(19) United States
(12) Patent Application Publication
(10) Pub. No.: US 2011/0139462 A1
(43) Pub. Date: Jun. 16, 2011

(54) METHODS OF INVESTIGATING AN UNDERGROUND FORMATION AND PRODUCING HYDROCARBONS, AND COMPUTER PROGRAM PRODUCT

(76) Inventor: Stephen James BOURNE, (US)

(21) Appl. No.: 12/523,340

(22) PCT Filed: Jan. 17, 2008
(86) PCT No.: PCT/EP08/50481

§ 371 Date: Apr. 1, 2010

(30) Foreign Application Priority Data
Jan. 19, 2007 (EP) 07100836.1

(51) Int. Cl. E21B 43/00; G01V 1/34; G06F 19/00; G06F 17/10

(52) U.S. Cl. 166/369; 702/16; 703/2

(57) ABSTRACT

A method of investigating an underground formation underneath the earth's surface, comprising obtaining a first data set representing change in a predetermined seismic parameter over a period of time for a plurality of points in the underground formation, which first data set is derived from a time-lapse seismic survey of the earth formation spanning the period of time; obtaining a second data set representing geodetic deformation over substantially the same period of time at a plurality of locations on the earth's surface, which second data set is derived from a geodetic survey spanning the period of time; jointly processing the first and second data sets to obtain a map of a parameter related to volume change in the underground formation; wherein a geomechanical model of the underground formation is postulated; also a method of producing hydrocarbons and a computer program.

### FIELD OF THE INVENTION

The present invention relates to a method of investigating an underground formation underneath the earth's surface.

### BACKGROUND OF THE INVENTION

There is a need for technologies that allow monitoring of depleting reservoir regions during production of hydrocarbons (oil and/or natural gas) from the reservoir. The geometric structure of a reservoir region is normally explored by geophysical methods, in particular seismic imaging of the subsurface during the exploration stage of an oil field. More difficult and less developed are methods that allow monitoring of the compaction of the depleting reservoir region over the course of production. One approach is to study the deformation such as displacement or tilt of the earth's surface above the region of the depleting reservoir. An example of such studies is the paper “Monitoring of fluid injection and soil consolidation using surface tilt measurements” by D. W. Vasco et al., Journal of Geotechnical and Geoenvironmental Engineering, January 1998, p. 29-37, and in this paper the estimation of subsurface volume changes given observations of surface displacement or tilt by inversion is discussed. Another example is the paper “Geodetic imaging: reservoir monitoring using satellite interferometry” by D. W. Vasco et al., Geophys. J. Int. (2002) vol 149, p. 555-571.

Another technology that is increasingly employed in recent years is time-lapse seismic surveying. In time-lapse seismic surveying, seismic data are acquired at least two points in time. Time is therefore an additional parameter with regard to conventional seismic surveying. This allows studying the changes in seismic properties of the subsurface as a function of time due to, for example, spatial and temporal variation in fluid saturation, pressure and temperature. Time-lapse seismic surveying is also referred to as 4 dimensional (or 4D) seismic, wherein time between acquisitions represents a fourth data dimension. Like in conventional seismic surveying, the three other dimensions relate to the spatial characteristics of the earth formation, two being horizontal length dimensions, and the third relating to depth in the earth formation, which can be represented by a length coordinate, or by a time coordinate such as the two-way travel time of a seismic wave from surface to a certain depth and back. Time-lapse seismic surveys study changes in seismic parameters over time, and in particular changes in two-way travel time can be studied.

International Patent application with publication No. WO2005/040858 discloses a method of investigating an underground formation using a time-lapse seismic survey. It has been found, that changes in e.g. two-way travel time can be observed outside a depleting reservoir region in the underground formation. This is a result of the impact of the volume change, that corresponds to the depletion, on the stress distribution in the surrounding formation. Stress changes cause changes in the seismic parameter seismic velocity, and therefore also in two-way travel time. A strain model for time-lapse time shift is discussed in the paper “Rocks under strain: Strain-induced time-lapse time shifts are observed for depleting reservoirs”, P. Hatchell and S. Bourne, The Leading Edge, December 2005, p. 1222-1225, and this strain model can be used to calculate the compaction of the depleting reservoir region. The calculation of a compaction map from a time-lapse seismic timeshift data is discussed in Hatchell, P. J., and S. J. Bourne, 2005, Measuring reservoir compaction using time-lapse timeshifts: 75th Annual International Meeting, SEG, Expanded Abstracts, 2500-2503.

A general difficulty in seismic surveying of oil or gas fields is that the reservoir region normally lies several hundreds of meters up to several thousands of meters below the earth's surface, but the thickness of the reservoir region or layer is comparatively small, i.e. typically only several meters or tens of meters. Sensitivity to detect small changes in the reservoir region is therefore an issue. Typically several years of production have to be awaited before clear differences can be detected and conclusions about reservoir properties can be drawn.

Issues similar to compaction of a depleting reservoir region arise in the case of an expansion of a subsurface region, in particular a reservoir region such as due to injection of a fluid into a subsurface formation, e.g. CO2 or water, or heating a subsurface region, in which case the region will expand.

The publication, “On the use of quasi-static deformation to understand reservoir fluid flow,” by D. W. Vasco et al., Geophys. J. Int. (2005) vol 70, p. 013-027 relates to a method for inferring reservoir volume changes and flow properties from observation of quasi-static deformation. This article vaguely suggests that “data from time-lapse seismic surveys could be used in conjunction or in place of surface deformation measurements.” However this is not elaborated upon.

To date, attempts to infer volume changes in the subsurface such as reservoir compaction have been partly successful but they may be incomplete and subject to bias. Many sources have related volume change to effective stress; however this is also an incomplete solution. Incompleteness arises because not all reservoir compaction induces measurable effects, e.g. on the surface or in time-lapse seismic surveys. Bias arises because of insufficient knowledge about the relationship between reservoir compaction and the measured parameters. There is a need for an improved method to investigate volume changes in an underground formation, so that in particular a more reliable mapping of the areal distribution of e.g. compaction of a depleting reservoir becomes possible.

### SUMMARY OF THE INVENTION

To this end the present invention provides a method of investigating an underground formation underneath the earth's surface, which method comprises
obtaining a first data set representing change in a predetermined seismic parameter over a period of time for a plurality of points in the underground formation, which first data set is derived from a time-lapse seismic survey of the earth formation spanning the period of time;
obtaining a second data set representing geodetic deformation over substantially the same period of time at a plurality of locations on the earth's surface, which second data set is derived from a geodetic survey spanning the period of time;
jointly processing the first and second data sets to obtain a map of a parameter related to volume change in the underground formation;
   wherein a geomechanical model of the underground formation is postulated, and used in the joint processing of the first and second data sets.

The invention is based on the insight gained by applicant that observations made in time-lapse seismic surveys and in geodetic surveys are complementary in various aspects, and that the synergies can be optimally exploited by joint processing of the data sets obtained by the two surveys.

Where a reservoir compacts, its top interface moves down pulling the overlying formations with it. This pull has two effects. The first effect is a downward displacement of the overburden manifest as subsidence and deformation at the surface. The second is a vertical elongation of the overburden manifest, which causes changes, typically an increase, in travel-times observed in time-lapse seismic.

Moreover, somewhat different aspects of the geomechanical relationships are exploited, that govern the effects that a subsurface volume change has on surface deformation and subsurface strain distribution (influencing seismic travel times). Treating both at the same time can significantly reduce uncertainties in the geomechanical model and increase robustness of the results obtained from an inversion. Furthermore, it has been realized that time-lapse seismic and geodetic data are sensitive to different horizontal length scales of underground deformation. Whereas time-lapse seismic data are most sensitive to short length scales of reservoir compaction, surface deformation is most sensitive to large length scales of reservoir compaction. A further advantage of joint processing is that gaps in any one of the data sets can be supplemented by data from the other.

According to the invention, a geomechanical model of the underground formation is postulated, and used in the joint processing of the first and second data sets. It has been found that even a relatively simple geomechanical model can provide good results given the complementary information contained in both data sets. As a further result of the joint processing an updated geomechanical model can be obtained that is consistent with both the first and the second data sets.

Suitably the geomechanical model is a linear model in which a linear relationship between the geodetic deformation data and the predetermined seismic parameter on the one hand, and the parameter related to volume change on the other hand is assumed. Linear models are beneficial, and using known inversion methods for such models an areal representation of underground volume change can be obtained from the data sets.

In particular the underground formation can comprise a reservoir region, and the volume change takes place in the course of production of fluid from, or injection of a fluid into, the fluid reservoir, or in the course of modifying the temperature of the reservoir region. More in particular, the map of a parameter related to volume change in the underground formation can be a map of one of compaction, expansion, fluid depletion, fluid enrichment, or temperature change, of the reservoir region.

From operating data in a particular field such as from production data of fluids from a reservoir or from injection volumes it is possible to obtain a parameter related to a net change of pore volume in the reservoir region in the course of the fluid production or injection. This parameter can with advantage also be used together with the first and second data sets to obtain the map of the parameter related to volume change. Suitably to this end, in the course of the processing of the first and second data sets, an overall compaction, expansion, fluid depletion, or fluid enrichment parameter for the reservoir region is determined, and this parameter is compared with the parameter related to a net change of fluid volume in the fluid reservoir in the course of the fluid production. In this way the estimated volume change and also the geomechanical model can be made consistent with all three sources of data.

The predetermined seismic parameter is preferably seismic travel time or two-way travel time.

The geodetic deformation data includes preferably at least one of subsidence, or non-vertical deformation of the earth's surface. Non-vertical deformation can for example be lateral displacement or tilt. Non-vertical displacement, and in particular displacement in the horizontal plane, is very sensitive to subsurface volume changes and has several advantages over vertical displacement or subsidence.

In a particular application, the method further comprises the step of identifying a zone of slip or localised shear on a weak interface or fault structure in the underground formation using the map of the parameter related to volume change. Reservoir volume changes may induce slip or localised shear on weak interfaces or fault structures close to or inside the reservoir. The magnitude of this deformation is capable of causing well failure or drilling problems that prevent wells reaching their intended targets. Knowledge about the location and geometry of these zones as well as the amount of slip accumulated provides options to mitigate or avoid the risk that wells exposed to this threat would face. For instance, fluid injection and production rates from the reservoir may be changed to avoid focusing further deformation on any structure identified to be slipping in response to reservoir volume changes. Also, any new wells may be planned to avoid these slipping structures.

The invention further provides a method for producing hydrocarbons from an underground formation, wherein the underground formation is investigated according to the invention.

The invention also provides a computer program product comprising program code that is loadable into a data processing system, wherein the data processing system by running the program code jointly processes first and second data sets to obtain a map of a parameter related to volume change in the underground formation according to the method of the present invention, wherein the first data set represents a change in a predetermined seismic parameter over a period of time for a plurality of points in the underground formation, which first data set is derived from a time-lapse seismic survey of the earth formation spanning the period of time, and wherein the second data set represents geodetic deformation over substantially the same period of time at a plurality of locations on the earth's surface, which second data set is derived from a geodetic survey spanning the period of time.

### BRIEF DESCRIPTION OF THE DRAWINGS

An embodiment of the invention will now be described in more detail and with reference to the accompanying drawings, wherein

FIG. 1 shows schematically an embodiment of a system for acquiring time-lapse seismic and geodetic data for the present invention;

FIG. 2 shows results from a model calculation of vertical displacements on the earth's surface and at the top and bottom of a compacting underground reservoir region, as a function of a size parameter S for the reservoir region;

FIG. 3 shows an example of a first data set an areal map of seismic timeshift measurements;

FIG. 4 shows an example of a second data set an areal map of geodetic deformation measurements over the same area as FIG. 3; and

FIG. 5 shows a compaction map obtained from joint processing of the data sets of FIGS. 3 and 4.

Where the same reference numerals are used in different Figures, they refer to the same or similar objects.

### DETAILED DESCRIPTION OF THE INVENTION

Areal monitoring of reservoir compaction is possible using geophysical measurements such as time-lapse seismic or surface subsidence. These two different measures of compaction are complementary. Where a reservoir compacts, its top interface moves down pulling the overlying formations with it. This deformation has two effects. The first is a downward displacement of the overburden manifest ultimately as subsidence at the surface. The second is a vertical elongation of the overburden manifest as increased travel-times observed in time-lapse seismic.

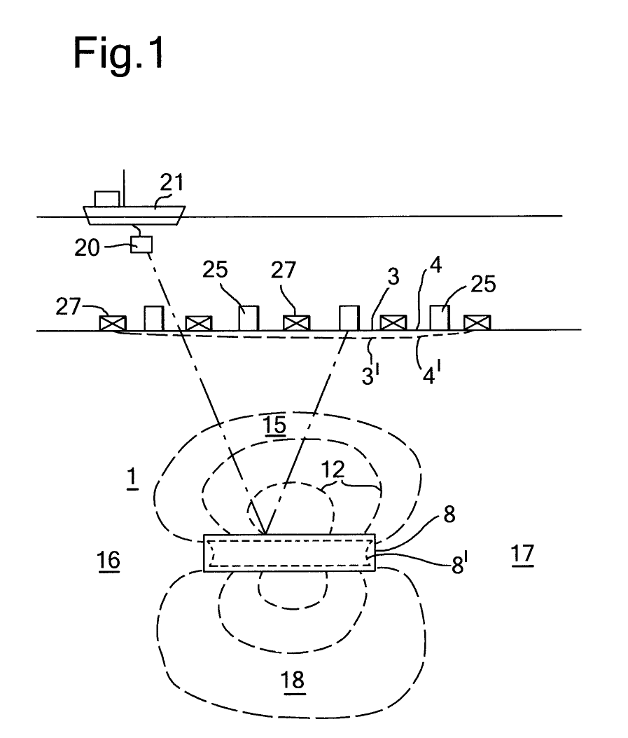

FIG. 1 illustrates schematically an example of the acquisition of geodetic and time-lapse seismic data in the situation of an offshore location. The underground formation 1 underneath the earth's surface 3, which in this example is the seafloor 4, includes a hydrocarbon reservoir 8 from which hydrocarbons such as oil and/or natural gas are produced. For the sake of clarity, the well penetrating the formation 1 and reservoir region 8 and through which fluids are produced to surface is not shown. The solid lines 3 and 8 indicate the earth's surface and the reservoir region at a first point in time, such as prior to the start of depletion or after some time of depletion of the reservoir region. Following depletion or further depletion, the volume of the reservoir region 8 has decreased at a second point in time, and the contracted reservoir region is indicated with reference numeral 8′. The earth's surface (seafloor) has also subsided and deformed, as indicated with reference numerals 3′, 4′. Also, the compaction has an influence on the stress distribution in the underground formation 1, and a particular effect can be stress arching indicated with reference numeral 12 wherein the overburden 15 above the reservoir region transfers part of its weight via the sideburden 16,17 around the reservoir region to the underburden or basement 18.

Time-lapse seismic data can be obtained by performing a seismic survey at the first and second points in time, i.e. over the period of time represented by these points in time. In the offshore example of FIG. 1, this can be done by activating a seismic source 20 from a ship 21, e.g. an airgun, and detecting the seismic wave 23 after its reflection at an interface in the underground formation at one of a plurality of seismic receivers 25 on or above the seafloor. The receivers can e.g. be arranged in an ocean bottom cable, but they can also be towed behind the ship 21. For the sake of clarity, only one raypath of a seismic wave is shown, wherein the reflection takes place at the interface between the reservoir region 8 and the overburden 15. Seismic waves will spread in other directions and reflections at various depths in the formation 1 occur, which is being registered by the plurality of receivers 25. Processing of the raw data yields a seismic representation of the subsurface with typically spatial coordinates in the horizontal directions and a travel time or two-way travel time in the depth direction, and from the time-lapse survey a representation of changes in e.g. two-way travel time for a plurality of locations in the underground formation can be obtained.

Complementary geodetic deformation data over the period of time can be obtained for example by placing a plurality of sensors 27 on the seafloor 3, which can detect e.g. pressure and/or gravity, from which depth can be calculated, horizontal (or non-vertical) deformation, or tilt at their respective locations. It will be understood that other geodetic methods can be applied as well to obtain the data set, e.g. using sensors or sonar imaging equipment carried on Remotely Operated Vehicles with precise positioning, fibre optic strain sensors anchored to the earths surface/sea floor, an array of acoustic transponders for monitoring non-vertical deformation, tilt sensors. In particular on land, other known geodetic methods and equipment can be used, for example satellite based measurements such as geodetic use of global positioning satellite systems (e.g., GPS), Laser ranging to satellites, synthetic aperture radar interferometry from orbit, but also more traditional geodetic techniques such as levelling, precision tilt meters and/or gravity measurements.

Non-vertical deformation can for example be lateral displacement or tilt. Non-vertical displacement, and in particular displacement in the horizontal plane, is very sensitive to subsurface volume changes and has several advantages over vertical displacement or subsidence. Direct measurement of the displacement by sensors on the sea floor is far less influenced by tidal effects, waves, and temperature effects in the entire water column. Contrary to intuition, the magnitude of horizontal displacements is comparable to the vertical displacements. In fact complementary signatures of subsurface volume changes to those from vertical displacements can be obtained from horizontal displacements. From the monitoring of the non-vertical displacement several parameters about the subsurface formation can be inferred. The compaction or expansion of the region in the subsurface formation can be studied directly, the depletion or accumulation of fluids in different subsurface regions can be derived, and if a plurality of fluid filled regions are present in the subsurface formation, the fluid connectivity between them can be studied. Moreover, lateral edges of regions undergoing a volume change can be detected and localized.

Preferably, the time-lapse data sets and the geodetic data sets are acquired at the same first and second points in time (wherein it will be appreciated that a point in time can be a finite period needed to conduct a measurement campaign such as a single seismic survey). If the timing is not identical, data can be interpolated or extrapolated.

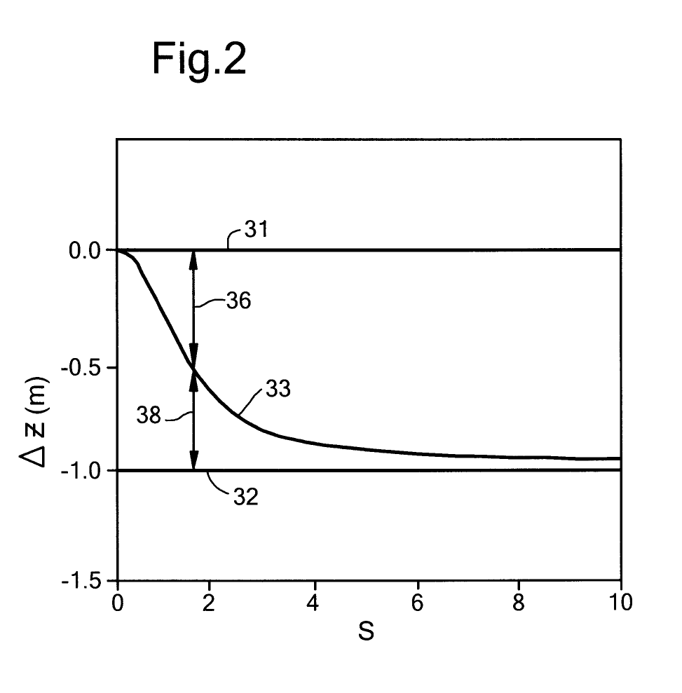

Reference is now made to FIG. 2, illustrating the aspect of complementary length scales probed by geodetic and time-lapse seismic data, respectively. The Figure displays results from a model calculation of the vertical displacement caused by a unit compaction, say a vertical compaction by 1 m, of a block-shaped underground reservoir region substantially as shown in FIG. 1. The Figure shows vertical displacement Δz for various positions along a vertical line through the centre of the reservoir, in dependence of a size parameter S, which is the ratio between lateral size of the reservoir region and the depth below the earth's surface. Subsidence corresponds to negative values of Δz. In the model calculation it has been assumed that the underburden of the reservoir region is rigid, i.e. there is no upward motion of the underburden due to the compaction of the reservoir region. The interface between reservoir region and underburden therefore does not move vertically, as seen in curve 31, and the compaction leads to a lowering of the interface between the reservoir region and the overburden by 1 m, see curve 32. Curve 33 depicts the lowering of the earth's surface. The distance 36 between curves 31 and 33 represents the surface subsidence, and the distance 38 between curves 32 and 33 represents the stretch in the overburden as a result of compaction. As can be seen from FIG. 2, for small values of the size parameter S, i.e. when the lateral extension of the compacting region is small compared to its depth, the effect is hardly seen in surface subsidence but gives rise to significant overburden stretch, leading to large effects on seismic velocities and two-way travel times. For large values of the size parameter, on the other hand, the overburden is much less stretched, and rather the surface deformation is much more pronounced.

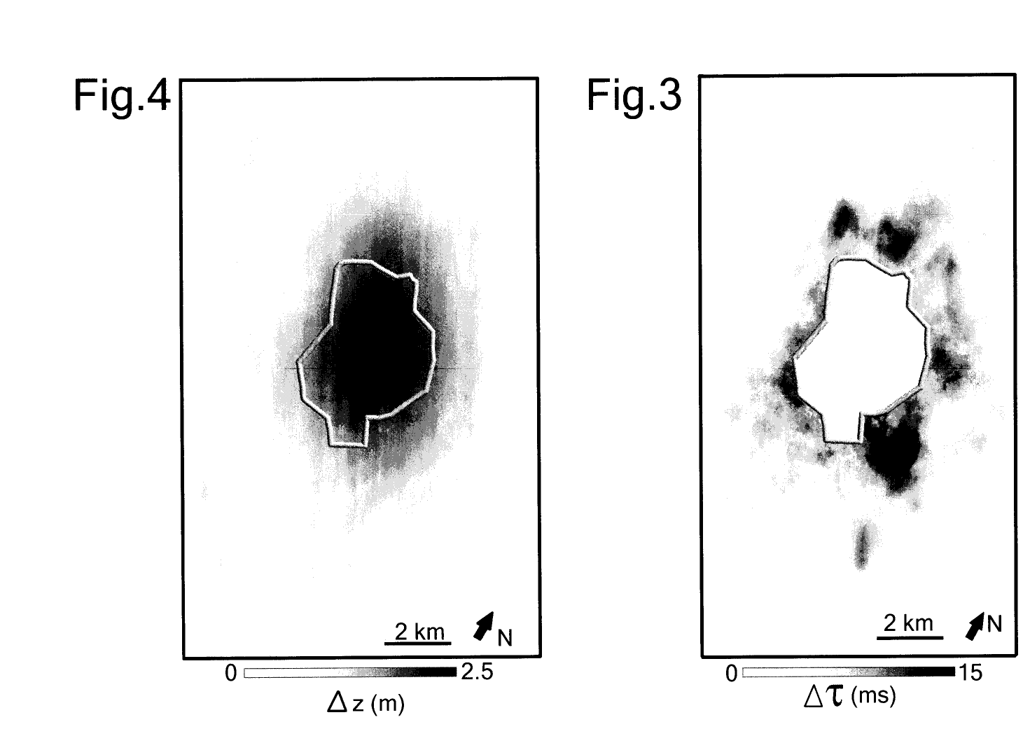

In the following the invention will be discussed at the hand of an example. Time-lapse seismic and geodetic deformation data sets were obtained for the Valhall oil field, located in the North Sea. For that field time-lapse seismic data sets from repeated streamer seismic and sonar data are available spanning the period from 1992 to 2002, during which time period hydrocarbons were produced from the field. The time-lapse timeshifts over this time period observed in the overburden of the producing reservoir region generally increase from the seafloor to the top reservoir. An areal map of seismic timeshift measurements at the top reservoir level is shown in FIG. 3. This first data set indicates up to 15 ms of additional two-way travel-time in the second survey compared to the first at the top reservoir, with a standard error of 0.5 ms. Their areal distribution is related to the pattern of drainage and compaction within the field. The masked central region denotes an area of a shallow gas cloud that prevents any reliable measurement of seismic (p-wave) timeshifts.

Seafloor (surface) subsidence was mapped for the same time period by a sonar bathymetry survey over the Valhall field in 1992, and again in 2001. Differences between these two measurements are shown in FIG. 4 and represent the second data set. One observes up to 2.5 m of seafloor subsidence over these nine years. The raw difference between these two surveys contained an apparently constant far-field subsidence of 0.56 m. This was removed to ensure zero subsidence, on average.

Now the joint processing of the first and second data sets will be discussed.

Any compaction of the reservoir will generate a characteristic pattern of seafloor subsidence and time-lapse timeshifts. The goal of processing is to discover the distribution of reservoir compaction consistent with these observations. This is also referred to as inversion of the data.

The nucleus of strain model for a homogeneous isotropic linear elastic half-space can be used to calculate surface subsidence and top reservoir timeshifts induced by reservoir compaction, and this model is for example discussed in Geertsma, J., Land subsidence above compacting oil and gas reservoirs, Journal of Petroleum Technology, 734-744, 1973. This model has been previously used to compute surface subsidence due to reservoir compaction, see e.g. Geertsma, J., “A basic theory of subsidence due to reservoir compaction: The homogeneous case”, Verhandelingen Kon. Ned. Mijnbouwk. Gen., v 28, p 43-62, 1973. For processing the data displayed in FIGS. 3 and 4 an extended version of this model was used to account for weak anisotropy. For the purpose of inversion, we represent the reservoir as a set of block-shaped strain nuclei arranged on a recti-linear grid, where each block spans the entire thickness of the reservoir region, which is embedded in the homogeneous isotropic linear elastic half-space. It was verified that our weakly anisotropic homogeneous half-space can be used as an equivalent to a multi-layered model in which the underground formation is represented by four horizontal layers each having uniform stiffness and a Poisson's ratio of 0.25, and stacked on top of a half-space, and with the reservoir located within the third layer down.

Our equivalent model possesses just two independent degrees of freedom: Poisson's ratio and delta. Delta is one of the three so-called Thomsen parameters used to described weak anisotropy. The other two Thomsen parameters are epsilon and gamma. Gamma has no effect on the deformations induced by reservoir compaction and the effects of epsilon are indistinguishable from those of delta. The presence of a rigid basement directly below the reservoir causes steeper flanks of the subsidence profile at horizontal distances larger than the half-width. So our equivalent model possesses three degrees of freedom: Poisson's ratio, delta, and the presence or absence of a rigid basement. Together, these degrees of freedom reproduce the behaviour of a general layered medium to within 5%. If measurement error for surface subsidence is no better than 5% then it is impossible to distinguish between a general layered model and the proposed three-parameter mechanical equivalent.

Alternatively, any suitable linear model for the relationship between a nucleus of strain and the deformation induced in the surrounding medium may be employed. These linear models may include other analytic or semi-analytic solutions or particular solutions obtained by numerical methods such as finite-element calculation.

The nucleus of strain formulation allows the forward model to be expressed as a matrix multiplication,

G·c=s (1),

where c is the vector with the n reservoir block strains and s the vector of m seafloor subsidence data points and top reservoir timeshifts. Top reservoir timeshifts can be calculated from the vertical displacement of the seafloor and the top reservoir following the method described in the above-mentioned paper by P. Hatchell and S. Bourne, The Leading Edge, December 2005, p. 1222-1225. A parameter that can be adapted in this method is the seismic timeshift-to-strain coupling parameter R.

The matrix elements Gij (i=1, . . . , m; j=1, . . . , n) relate the response at the i-th observation location to the volume change of the j-th subsurface block, and represent an embodiment of the geomechanical model applied. The total response at an observation location is the sum of the responses to all the individual reservoir blocks. As the forward model is linear, the inversion problem can be solved using the method of least squares, i.e. by minimising the norm of residuals,

∥G·c−s∥². (2)

As solution, the set of strains of the n reservoir blocks is obtained, which represents a map of a parameter related to volume change (compaction) of the reservoir region in the underground formation. Depending on the distribution of observations, this problem may be ill defined. In this case, additional constraints such as smoothness can be introduced to obtain a solution. Well-known methods to do this are singular value decomposition, and regularisation.

The raw subsidence data set comprises measurements at 25,000 discrete locations. The raw time-lapse timeshift data at top reservoir comprise 300,000 discrete measurements. The amount of data used for inversion was reduced using a so-called quadtree representation of data used for inversion, to just 1,000 discrete measurements of subsidence and 7000 timeshift measurements for various locations. This choice simply reflects the desire to avoid longer computation times at this point. In the quadtree representation, the areal distribution of data is decomposed into a hierarchical structure of square cells each representing a constant value, wherein the size of the cells depends on the local variance of data. By setting the variance threshold according to the standard measurement error, this process significantly reduces the number of observations but not their information content.

As a third source of information, analysis of production history provides the total reduction in reservoir pore volume. Over the period 1992-2002, history-matched reservoir simulations constrain the total field-wide reduction in reservoir pore volume. Corresponding total compaction figures can be obtained from the inversion of geodetic and seismic timeshift data to compaction maps. By including the pore-volume reduction figure obtained from the production history in the joint inversion, one can obtain a single model of reservoir compaction consistent with all three independent data sources within the data error.

Solutions obtained by joint inversion of these data depend on several factors. First, a relative weight factor included for each data source determines the strength of its contribution. If the weight factor for one data source is too large then all benefits from the other will be lost. One can avoid this by selecting weights according to the standard measurement error for each data source. Second, by including a regularisation weight factor one can influence the degree of smoothness obtained in the solution. If this weight factor is too large then the solution will be too smooth as so fail to match the data. If this weight factor is too small then the solution may fit all the data but suffer instabilities resulting in erroneous short wavelength details with no physical significance. One can for example choose the regularisation weight factor such as to select the smoothest solution consistent with the available data.

Third, the key parameters describing the effective geomechanical medium govern the exact relationship between compaction, subsidence, and timeshifts. Instead of the anisotropic homogeneous half-space model with the presence or absence of a rigid basement directly below the reservoir, as described hereinbefore, other models can be applied as well. The anisotropic homogeneous half-space model can be treated analytically, but in principle numerical models such as using finite-element calculations can also be applied. Other, more complex and possibly more complete semi-analytic or numerical models can be used.

A systematic grid search over the range of physical values for the effective Poisson's ratio, Thomsen's weak anisotropy parameter delta, the presence or absence of a rigid basement, and the seismic timeshift-to-strain coupling parameter R outside the reservoir, was found to succeed in finding a single minimum in the misfit to all three data sources. This misfit M is defined as

M=sqrt(rₛ²+rₜ²+rᵥ²), (3)

where r is the root-mean-square of residual for a single data source normalised by their stand error, and the subscripts s, t, v refer to subsidence, timeshift, and reservoir volume data sources, respectively.

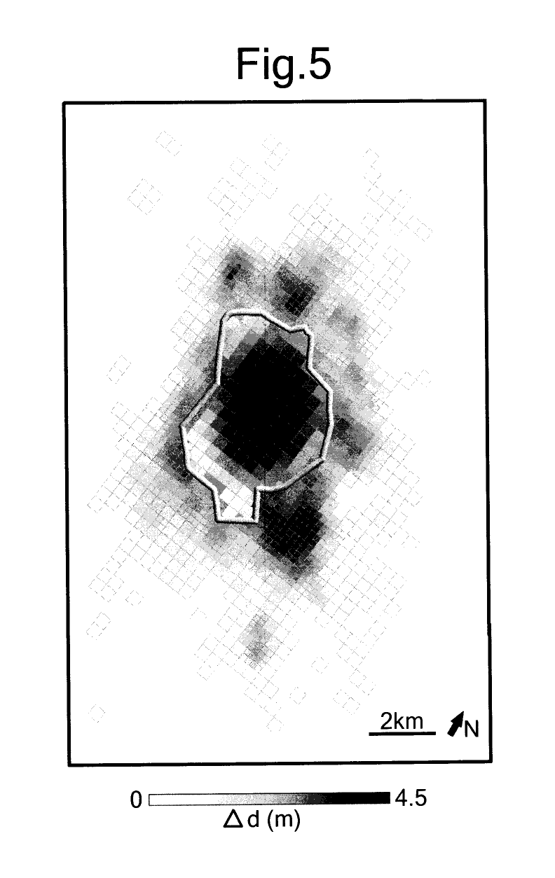

For the joint processing of the different data set, the small difference between acquisition times of the time-lapse seismic and geodetic surveys were corrected by interpolation. The result of the joint processing of the three data sets in the present example, using a data processing system running program code from a computer program product, is shown in FIG. 5, which Figure shows a map of local vertical compaction of the reservoir region. As this result is consistent with all three data sources, it represents both the long- and short scale effects probed by the subsidence and seismic time-shift measurements, that are visible in FIGS. 3 and 4. Moreover, the blind spot in the time-lapse data could be filled. Compared with previous model-driven results, this data driven approach realises significant uncertainty reduction by exploiting the full accuracy of all data.

In the detailed description the situation of a depleting and compacting reservoir region was specifically discussed for the sake of clarity. It will be understood however, that the present invention is equally applicable in case of an injection of fluid, or in fact in case of a temperature change of the subsurface formation such as during heating of the formation region, which leads to expansion. In this case it is also possible to determine a temperature map.

1. A method of investigating an underground formation underneath the earth's surface, which method comprises
obtaining a first data set representing change in a predetermined seismic parameter over a period of time for a plurality of points in the underground formation, which first data set is derived from a time-lapse seismic survey of the earth formation spanning the period of time;
obtaining a second data set representing geodetic deformation over substantially the same period of time at a plurality of locations on the earth's surface, which second data set is derived from a geodetic survey spanning the period of time;
jointly processing the first and second data sets to obtain a map of a parameter related to volume change in the underground formation;
wherein a geomechanical model of the underground formation is postulated, and used in the joint processing of the first and second data sets.

2. The method according to claim 1, wherein as a further result of the joint processing an updated geomechanical model is obtained that is consistent with the first and second data sets.

3. The method according to claim 1 or 2, wherein the geomechanical model is a linear model in which a linear relationship between the geodetic deformation data and the predetermined seismic parameter on the one hand, and the parameter related to volume change on the other hand is assumed.

4. The method according to any one of claims 1-3, wherein the underground formation comprises a reservoir region, and wherein the volume change takes place in the course of production of fluid from, or injection of a fluid into, the fluid reservoir, or in the course of modifying the temperature of the reservoir region.

5. The method according to claim 4, wherein the map of a parameter related to volume change in the underground formation is a map of one of compaction, expansion, fluid depletion, fluid enrichment, or temperature change, of the reservoir region.

6. The method according to claim 5, further comprising the step of obtaining a parameter related to a net change of pore volume in the reservoir region in the course of the fluid production or injection, and using this parameter together with the first and second data sets to obtain the map of the parameter related to volume change.

7. The method according to any one of claims 1-6, wherein in the course of the processing of the first and second data sets an overall compaction, expansion, fluid depletion, or fluid enrichment parameter for the reservoir region is determined, and wherein this parameter is compared with the parameter related to a net change of fluid volume in the fluid reservoir in the course of the fluid production.

8. The method according to any one of claims 1-7 wherein the predetermined seismic parameter is seismic travel time or two-way travel time.

9. The method according to any one of claims 1-7 wherein the geodetic deformation data includes at least one of subsidence, or non-vertical deformation of the earth's surface.

10. The method according to any one of claims 1-9, further comprising the step of identifying a zone of slip or localised shear on a weak interface or fault structure close in the underground formation using the map of the parameter related to volume change.

11. A method for producing hydrocarbons from an underground formation, wherein the underground formation is investigated by the method of any one of claims 1-10.

12. A computer program product comprising program code that is loadable into a data processing system, wherein the data processing system by running the program code jointly processes first and second data sets to obtain a map of a parameter related to volume change in the underground formation according to the method of any one of claims 1-11, wherein the first data set represents a change in a predetermined seismic parameter over a period of time for a plurality of points in the underground formation, which first data set is derived from a time-lapse seismic survey of the earth formation spanning the period of time, and wherein the second data set represents geodetic deformation over substantially the same period of time at a plurality of locations on the earth's surface, which second data set is derived from a geodetic survey spanning the period of time.
